(19) United States
(12) Patent Application Publication
(10) Pub. No.: US 2022/0301792 A1
(43) Pub. Date: Sep. 22, 2022

(54) SWITCH DEVICE

(71) Applicant: KABUSHIKI KAISHA TOKAI RIKA DENKI SEISAKUSHO, Aichi (JP)

(72) Inventors: Akito ISHIHARA, Aichi (JP); Yuichiro SATO, Aichi (JP); Koji KOBAYASHI, Aichi (JP)

(21) Appl. No.: 17/635,862

(22) PCT Filed: Jul. 31, 2020
(86) PCT No.: PCT/JP2020/029469

§ 371 Date: Feb. 16, 2022

(30) Foreign Application Priority Data
Sep. 5, 2019 (JP) 2019-162195

(51) Int. Cl. H01H 23/30; H01H 23/16; B60J 1/17; H01H 23/04

(52) U.S. Cl. CPC H01H 23/30; H01H 23/16; B60J 1/17; H01H 23/04

(57) ABSTRACT

A switch device includes an operation knob unit integrally including an operation knob, a detection part to detect proximity to or contact with the operation knob, a conduction part electrically connected to the detection part, a first control unit that is electrically connected to the detection part via the conduction part, determines proximity to or contact with the operation knob based on a first output signal outputted from the detection part and outputs a determination result as a second output signal, and a sub-substrate that is attached to the operation knob and includes the first control unit.

### CROSS-REFERENCES TO RELATED APPLICATIONS

The present patent application claims the priority of Japanese patent application No. 2019/16219.5 Filed on Sep. 5, 2019, and the entire contents of Japanese patent application No. 2019/162195 are hereby incorporated by reference.

### TECHNICAL FIELD

The present invention relates to a switch device.

### BACKGROUND ART

A switch device is known which includes plural operation knobs to be operated, switch mechanisms that open/close a set of switch elements when driven by the operation knobs and have bottom surfaces on which plural connection terminals are provided, and a substantially rectangular substrate having a conductive pattern electrically connected to the plural connection terminals (see, e.g., Patent Literature 1).

This switch device is a switch device for a power window device to open/close windows of a vehicle.

### CITATION LIST

### Patent Literature

Patent Literature 1: JP 2015/173011 A

### SUMMARY OF INVENTION

### Technical Problem

In case that detection electrodes to detect contact are arranged on the operation knobs in the switch device disclosed in Patent Literature 1 and the detection electrodes are connected to the substrate of the switch device by a flat cable, etc., malfunction may occur due to an effect of noise since the detection electrodes are far from the substrate.

It is an object of the invention to provide a switch device capable of reducing the effect of noise.

### Solution to Problem

A switch device in an embodiment of the invention comprises:
an operation knob unit integrally comprising an operation knob, a detection part to detect proximity to or contact with the operation knob, a conduction part electrically connected to the detection part, a first control unit that is electrically connected to the detection part via the conduction part, determines proximity to or contact with the operation knob based on a first output signal outputted from the detection part and outputs a determination result as a second output signal, and a sub-substrate that is attached to the operation knob and comprises the first control unit.

### Advantageous Effects of Invention

According to an embodiment of the invention, it is possible to provide a switch device capable of reducing the effect of noise.

### BRIEF DESCRIPTION OF DRAWINGS

FIG. 1 is an exploded view showing an example of a switch device in an embodiment.

FIG. 2A is a block diagram illustrating an operation knob unit of the switch device in the embodiment.

FIG. 2B is a block diagram illustrating the switch device in the embodiment.

FIG. 3A is a perspective view showing an operation direction of all operation knob of the switch device in the embodiment.

FIG. 3B is an explanatory diagram illustrating a door of a vehicle on which the switch device is arranged.

FIG. 4A is a top view showing the operation knob tout of the switch device in the embodiment.

FIG. 4B is a bottom view showing the operation knob unit of the switch device in the embodiment.

FIG. 5A is a bottom view showing the operation knob unit of the switch device in the embodiment when a cover is removed.

FIG. 5B is a bottom view showing the operation knob unit when a sub-substrate is further removed from the state shown in FIG. 5A.

FIG. 5C is an explanatory perspective view showing arrangement of a conduction part of the switch device in the embodiment.

FIG. 6A is a perspective view when the operation knob of the switch device in the embodiment is viewed from the front.

FIG. 6B is an explanatory diagram for explaining a detection electrode unit and the conduction part of the switch device in the embodiment.

FIG. 7A is an explanatory diagram illustrating detection electrodes and the sub-substrate of the switch device in the embodiment.

FIG. 7B is a top view showing the sub-substrate of the switch device in the embodiment.

FIG. 8A is an explanatory diagram for explaining how a cable is attached in the switch device in the embodiment.

FIG. 8B is a top view showing a main substrate of the switch device in the embodiment.

FIG. 8C is a perspective view for explaining how the cable is attached in the switch device in the embodiment.

### DESCRIPTION OF EMBODIMENTS

(Short summary of the embodiment)

A switch device in an embodiment has an operation knob unit integrally including an operation knob, a detection part to detect proximity to or contact with the operation knob, a conduction part electrically connected to the detection part, a first control unit that is electrically connected to the detection part via the conduction part, determines proximity to or contact with the operation knob based on a first output signal outputted from the detection part and outputs a determination result as a second output signal, and a sub-substrate that is attached to the operation knob and comprises the first control unit.

In this switch device, a determination result is outputted from the operation knob unit. Therefore, as compared to when contact is determined by a control unit arranged in the main body to which the operation knob is attached, a portion from the detection unit to the first control unit, which is likely to be affected by noise, is short and it is thus possible to suppress the effect of noise.

### EMBODIMENT

(General Configuration of a Switch Device 1)

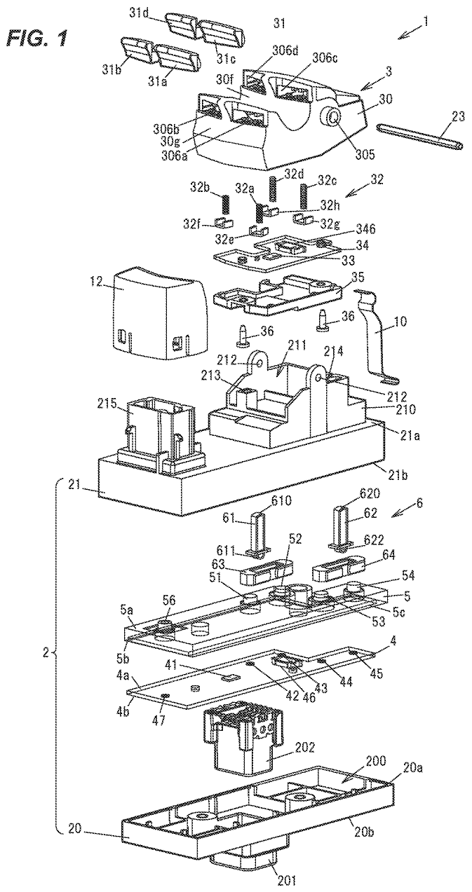

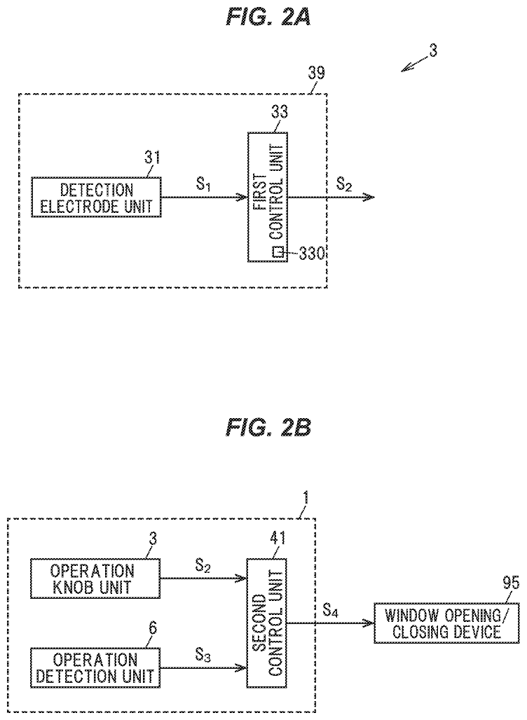

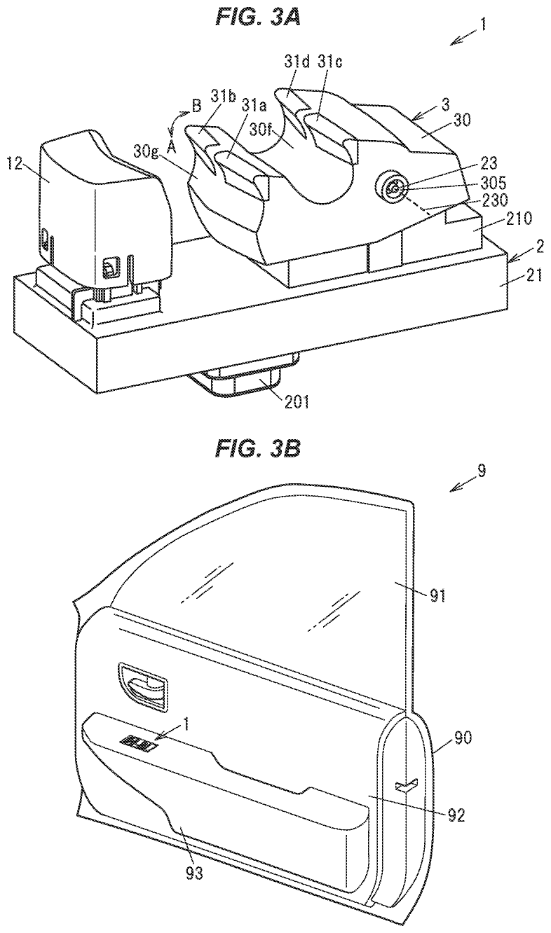

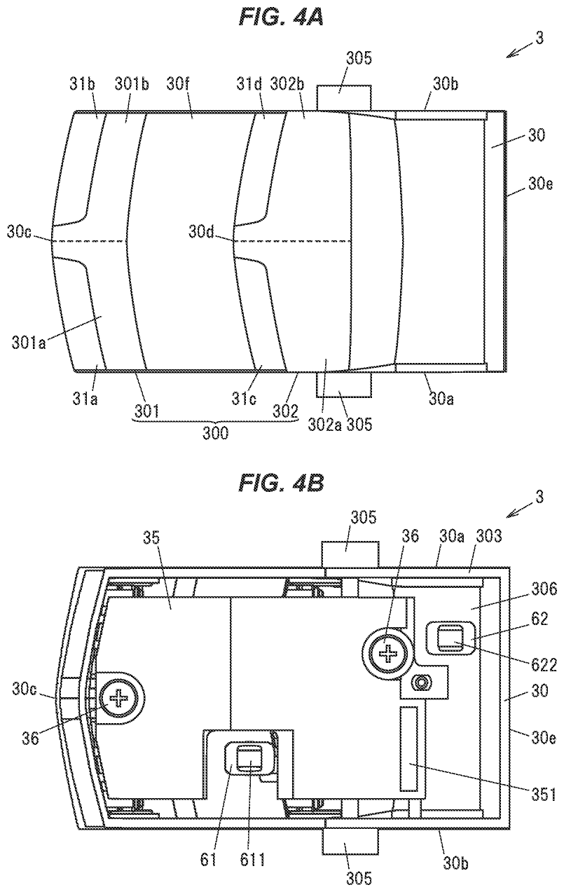

FIG. 1 is an exploded view showing a switch device. FIG. 2A is a block diagram illustrating an operation knob unit, and FIG. 2B is a block diagram illustrating the switch device. FIG. 3A is a perspective view showing an operation direction of an operation knob, and FIG. 3B is an explanatory diagram illustrating a door of a vehicle on which the switch device is arranged, FIG. 4A is a top view showing the operation knob unit, and FIG. 4B is a bottom view showing the operation knob unit. In each drawing of the embodiment described below, a scale ratio may be different from an actual ratio. In addition, in FIGS. 2A and 2B, flows of main signals and information are indicated by arrows.

The switch device 1 in the present embodiment is used to give an instruction to open/close windows of a vehicle as an example, but it is not limited thereto. It can be widely used as a switch device that integrates plural switches on one operation knob.

In the following description, a front-and-rear direction of the switch device 1 is a horizontal direction of the paper of FIG. 1, where the left side is the front and the right side is the rear. In addition, a left-and-right direction of the switch device 1 is a direction orthogonal to the front-and-rear direction, where the near side of the paper of FIG. 1 is the left and the far side is the right. In addition, an up-and-down direction of the switch device 1 is the vertical direction of the paper of FIG. 1. These front-and-rear, left-and-right, and up-and-down directions coincide with the front-and-rear, left-and-right, and up-and-down directions of the vehicle.

As shown in FIGS. 1 and 2A, the switch device 1 has an operation knob unit 3 that integrally includes an operation knob 30, a detection electrode unit 31 as a detection part to detect proximity to or contact with the operation knob 30, a conduction part 32 electrically connected to the detection electrode unit 31, a first control unit 33 that is electrically connected to the detection electrode unit 31 via the conduction part 32, determines proximity to or contact with the operation knob 30 based on a first output signal S₁ outputted from the detection electrode unit 31 and outputs a determination result as a second output signal S₂, and a sub-substrate 34 that is attached to the operation knob 30 and has the first control unit 33.

As shown in FIGS. 1 to 2B, the switch device 1 further includes a main body 2 to which the operation knob unit 3 is attached, an operation detection unit 6 to detect an operation performed on the operation knob 30, a cable 10 electrically connected to the first control unit 33, a second control unit 41 that acquires the second output signal S₂ outputted by the first control unit 33 through the cable 10 and outputs an instruction signal S₄ to give an instruction to an operation target based on the operation detected by the operation detection unit 6 and the second output signal S₂, and a main substrate 4 which is arranged in the main body 2 and is electrically connected to the sub-substrate 34 via the cable 10 and on which the second control unit 41 is mounted.

As shown in FIGS. 3A to 4A, the operation knob 30 has a surface 300 divided into plural operation regions and is attached to the main body 2 so that pull-up operation and push-down operation thereof can be performed about a rotation axis 230. This rotation axis 230 is a central axis of a shaft 23 that is inserted into an insertion hole 305 to penetrate through an attachment part 210 and the operation knob 30 at the time of attachment to the attachment part 210 of the main body 2, The operation knob 30 rotates about the shaft 23 in an arrow A direction and an arrow B direction which is a direction opposite to the arrow A direction. The push-down operation is an operation performed in the arrow A direction shown in FIG. 3A. The pull-up operation is an operation performed in the arrow B direction.

As shown in FIG. 2B, the operation detection unit 6 outputs a third output signal S₃ indicating which of the pull-up operation and the push-down operation is the performed operation.

As shown in FIG. 2B, the second control unit 41 outputs the instruction signal S₄ indicating the operated operation region and the performed operation to the operation target based on the second output signal 52 outputted from the operation knob unit 3 and the third output signal S₃ outputted from the operation detection unit 6.

The operation target in the present embodiment is a window opening/closing device 95 to open/close windows of a vehicle 9, as shown in FIG. 3B. The operation knob 30 has at least four operation regions corresponding to left and right front windows and left and right rear windows of the vehicle 9. The second control unit 41 is configured to determine the operated operation region and the performed operation based on the second output signal S₂, and the third output signal S₃, and output the instruction signal S₄ indicating which window is to be opened or closed.

The switch device 1 has eight different functions: functions of giving instructions to open and close the left and right front windows and open and close the left and right rear windows.

The switch device 1 is arranged on an armrest 93 provided on a door trim 92 of a front-right door 90 of the vehicle 9, as shown in FIG. 3B. The vehicle 9 in the present embodiment has four doors as an example, but it is not limited thereto. It may have two doors. In such a case, the operation knob 30 includes two operation regions.

(Configuration of the Main Body 2)

As shown in FIG. 1, the main body 2 is composed of a lower case 20 and an upper case 21. The main body 2 is formed using a resin material. The main body 2 is configured as a housing which is long in the front-and-rear direction.

The upper case 21 has a box shape in which a lower surface 21b is open. The lower case 20 is fitted on the lower surface 21b side so that the main substrate 4, a rubber dome sheet 5 and the operation detection unit 6 are sandwiched, and the lower case 20 and the upper case 21 are integrated by screws.

The lower case 20 has a box shape in which an upper surface 20a is open, and the inside of the box serves as a housing part 200. The main substrate 4 and the rubber dome sheet 5 are integrally housed in the housing part 200. A connector case 201 is provided on a lower surface 20b. A connector 202 having plural pins electrically connected to an electronic circuit on the main substrate 4 is inserted into the connector case 201.

On an upper surface 21a of the upper case 21, the attachment part 210 is provided at the rear and a guide part 215 at the front, as shown in FIG. 1. The attachment part 210 has a rectangular cylindrical shape. Insertion holes 212 through which the shaft 23 is inserted are provided on a pair of opposite sides of the attachment part 210 which face each other in the left-and-right direction.

As shown in FIG. 1, a guide hole 213 and a guide hole 214 which have a cylindrical shape are further provided on the attachment part 210 at the front and rear of an internal space 211. A rod 61 and a rod 62 are inserted into the guide hole 213 and the guide hole 214.

An operation button 12 is attached to the guide part 215 in a push operable manner. The operation button 12 is, e.g., a button to switch between locking and unlocking of the operation knob 30. Locking the operation knob 30 means that the operation knob 30 cannot be operated. Unlocking the operation knob 30 means that the operation knob 30 can be operated.

(Configuration of the Operation Knob Unit 3)

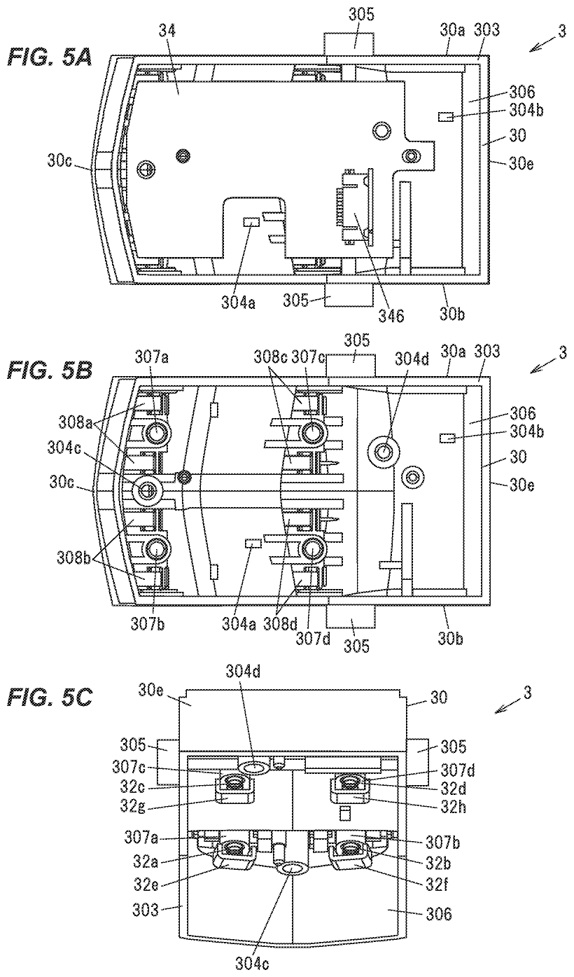

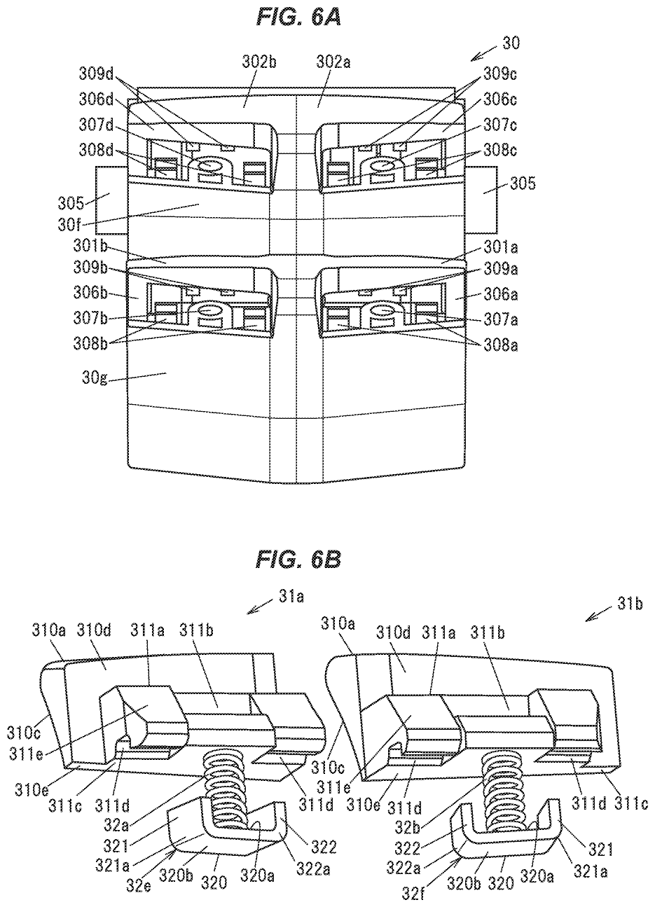

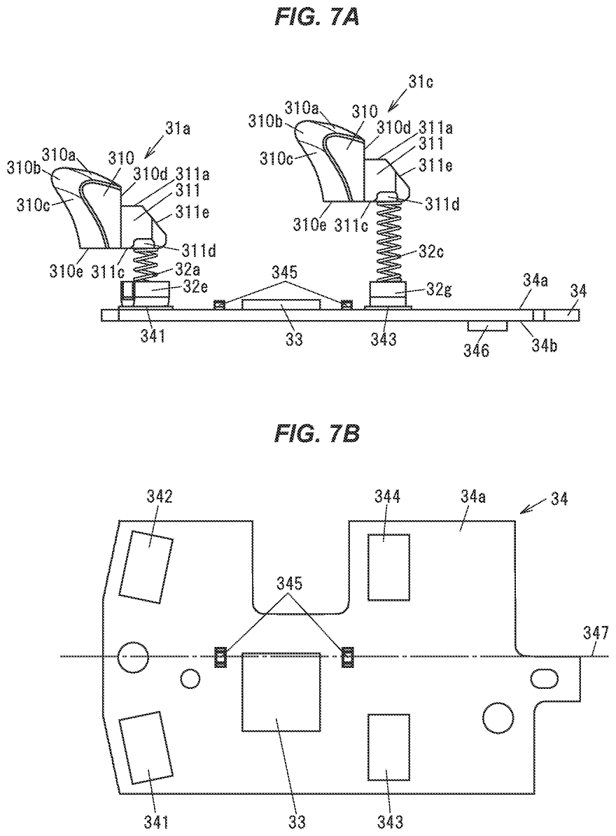

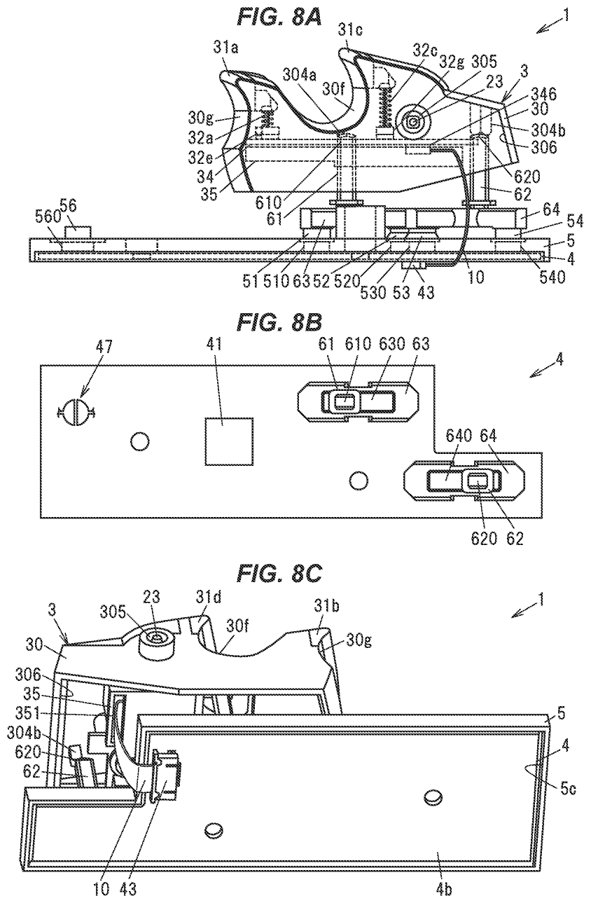

FIG. 5A is a bottom view showing the operation knob unit when a cover is removed, FIG. 5B is a bottom view showing the operation knob unit when a sub-substrate is further removed, and FIG. 5C is an explanatory perspective view showing arrangement of the conduction part. FIG. 6A is a perspective view when the operation knob is viewed from the front, and FIG. 6B is an explanatory diagram for explaining the detection electrode unit and the conduction part. FIG. 7A is an explanatory diagram illustrating detection electrodes and the sub-substrate, and FIG. 7B is a top view showing the sub-substrate. FIG. 8A is an explanatory diagram for explaining how the cable is attached, FIG. 8B is a top view showing the main substrate, and FIG. 8C is a perspective view for explaining how the cable is attached.

The surface 300 of the operation knob 30 is divided into plural operation regions. The detection electrode unit 31 is arranged for each of the plural operation regions. The first control unit 33 determines which of the plural operation regions is contacted based on the first output signal S₁, and outputs the second output signal S₂ indicating the operation region in which the contact is detected.

The surface 300 of the operation knob 30 in the present embodiment is divided into plural regions by at least one recessed part formed thereon, and the plural regions are further divided into the plural operation regions. Next, a configuration of the operation knob unit 3 in the present embodiment will be described, and the operation regions, etc., will be also described.

(Configuration of the Operation Knob 30)

The operation knob 30 is formed using a resin material. As shown in FIGS. 4A to 5C, the operation knob 30 is long in the front-and-rear direction and is open on a lower surface 303, and the inside thereof serves as a housing part 306. Mainly the sub-substrate 34 and the conduction part 32 are housed in the housing part 306.

As shown in FIGS. 3A and 4A, a recessed part 30f into which a user can insert a finger is provided on the surface 300 of the operation knob 30. The recessed part 30f is formed from a left-side surface 30a to a right-side surface 30b of the operation knob 30.

As shown in FIG. 4A, the surface 300 of the operation knob 30 is divided into plural regions; a front region 301 and a rear region 302, by the recessed part 30f The front region 301 of the operation knob 30 is further divided into the plural operation regions; a left front-side operation region 301a and a right front-side operation region 301b. Furthermore, the rear region 302 of the operation knob 30 is further divided into the plural operation regions; a left rear-side operation region 302a and a right rear-side operation region 302b.

Dotted lines added on the left and right in FIG. 4A indicate an example boundary between the left front-side operation region 301a and the right front-side operation region 301b and an example boundary between the left rear-side operation region 302a and the right rear-side operation region 302b. The dotted lines in FIG. 4A are center lines dividing the surface 300 of the operation knob 30 into right and left.

The left front-side operation region 301a is a region including an upper surface 310a of a detection electrode 31a. The right front-side operation region 301b is a region including an upper surface 310a of a detection electrode 31b. The left rear-side operation region 302a is a region including an upper surface 310a of a detection electrode 31c. The right rear-side operation region 302b is a region including an upper surface 310a of a detection electrode 31d.

As shown in FIG. 4A, an end portion 30c of the front region 301 has a shape which is curved so that both edges are located rearward relative to a tip in a state in which the detection electrode unit 31 is attached. Likewise, an end portion 30d of the rear region 302 has a shape which is curved so that both edges are located rearward relative to a tip in the state in which the detection electrode unit 31 is attached.

The recessed part 30f is a groove having a substantially circular cross section in a lateral direction and has a shape curved at the center line dividing the operation knob 30 into right and left and extending rearward.

A recessed part 30g is provided at the front end of the operation knob 30. The recessed part 30g is shaped to allow the user to easily hook the operation finger and is curved so that both edges are located rearward relative to the front end, in the similar manner to the recessed part 30f inside the housing part 306, the operation knob 30 has a protrusion 304a provided on a back side of the recessed part 30f and a protrusion 304b provided on a rear end portion 30e side, as shown in FIG. 5A. An upper part 610 of the rod 61 is in contact with the protrusion 304a. Likewise, an upper part 620 of the rod 62 is in contact with the protrusion 304b.

As shown in FIG. 4B, a cover 35 to hold the sub-substrate 34 housed in the housing part 306 is attached to the operation knob 30. The cover 35 is integrated with the operation knob 30 by tightening screws 36 inserted into a screw mounting hole 304c and a screw mounting hole 304d provided in the housing part 306, as shown in FIG. 5B. Holes corresponding to the screw mounting hole 304c and the screw mounting hole 304d are provided on the cover 35, and the screws 36 are inserted into the screw mounting hole 304c and the screw mounting hole 304d through such holes.

As shown in FIG. 4B, the cover 35 has an opening 351 at the rear. The opening 351 has a rectangular shape which is long in the left-and-right direction, and the cable 10 is inserted therethrough.

As shown in FIG. 6A, the operation knob 30 has attachment openings 306a-306d to which the detection electrodes 31a-31d of the detection electrode unit 31 are attached. Cylindrical parts 307a-307d, lower claw parts 308a-308d and upper claw parts 309a-309d are also provided on the operation knob 30 so as to correspond to the attachment openings 306a-306d.

As shown in FIGS. 5C and 6A, the cylindrical parts 307a-307d have a cylindrical shape, and springs 32a-32d are inserted thereinto. The lower claw parts 308a-308d are provided as pairs of claws facing each other via the cylindrical parts 307a-307d. The upper claw parts 309a-309d are provided as pairs of claws facing each other above the cylindrical parts 307a-307d. The detection electrodes 31a-31d are sandwiched between the lower claw parts 308a-308d and the upper claw parts 309a-309d and thereby attached to the operation knob 30.

Configuration of the Detection Electrode Unit 31

The detection electrode unit 31 is an electrode part of the self-capacitance type electrostatic sensor 39 that detects a change in capacitance caused by proximity or contact of an operation finger of a user. The electrostatic sensor 39 has the detection electrode unit 31, the conduction part 32, and the first control unit 33.

The detection part is not limited to the detection electrode unit 31, and may be a sensor part to detect contact with the operation knob 30, such as a pressure sensor or a load sensor.

The detection electrode unit 31 includes the detection electrodes 31a-31d. The detection electrodes 31a-31d are formed using a highly conductive metal material. As shown in FIGS. 3A and 4A, exposed parts of the detection electrodes 31a-31d have shapes corresponding to the operation knob 30.

Since the detection electrodes 31a-31d have the same basic configuration, the configuration of the detection electrode 31a will be mainly described below. The same reference signs as those used for the detection electrode 31a are also used for the detection electrodes 31b-31d.

As shown in FIGS. 6B and 7A, the detection electrode 31a has a base part 310 and an attachment part 311.

The base part 310 is a portion to be contacted by a finger of the user. The upper surface 310a, an end 310b and a front surface 310c of the base part 310 are exposed from the operation knob 30. The upper surface 310a is smoothly connected to the surface 300 of the operation knob 30. The end 310b is located between the upper surface 310a and the front surface 310c and has a rounded and curved shape. The front surface 310c has a rounded, recessed and curved shape so that a finger of the user fits therein.

When performing a push-down operation, the user brings the operation finger into contact with the upper surface 310a and pushes the operation knob 30 down. Meanwhile, when performing a pull-up operation, the user pulls up the operation knob 30 by hooking the operation finger on the front surface 310c. The detection electrode unit 31 detects proximity to or contact of the operation finger during such operations.

The attachment part 311 is provided so as to protrude from a back surface 310d of the base part 310 in a normal direction. The attachment part 311 has a flat upper surface 311a and an inclined surface 311e that is inclined from an edge of the upper surface 311a. The attachment part 311 has a recessed part 311b in the middle of the upper surface 331a and the inclined surface 311e. The upper claw parts 309a-309d provided in the attachment openings 306a-306d of the operation knob 30 are inserted into the recessed parts 311b.

A lower surface 310e of the base part 310 and the lower surface 311c of the attachment part 311 are smoothly connected and form one surface. Two recessed parts 311d are provided on the left and right of the lower surface 311c at opposite positions, as shown in FIG. 6B. The lower claw parts 308a-308d provided in the attachment openings 306a-306d of the operation knob 30 are inserted into the recessed parts 311d. In the operation knob unit 3, each of the springs 32a-32d is in contact with the lower surface 311c between the two recessed parts 311d. This contact of the springs 32a-32d provides electrical conduction between the springs and the detection electrodes. As a modification, raised parts to be inserted into the centers of the springs may be provided on the lower surfaces 311c to be in contact with the springs 32a-32d.

Configuration of the Conduction Part 32

The conduction part 32 includes the springs 32a-32d and arrangement bases 32e-32h. The springs 32a-32d are coil springs formed using a metal material having elasticity as well as conductivity, such as carbon steel. The arrangement bases 32e-32h are formed by bending a metal plate of brass, etc., having conductivity. The conductive members connecting the detection electrode unit 31 to the arrangement bases 32e-32h are not limited to the coil springs and may be plate springs, disc springs, or conductive rubbers, etc., having elasticity, as a modification.

The spring 32a and the spring 32b have the same length. The spring 32c and the spring 32d have the same length. The length of the spring 32a and the spring 32b arranged on the front region 301 side of the operation knob 30 is different from and shorter than the length of the spring 32c and the spring 32d arranged on the rear region 302 side.

Since the arrangement bases 32e-32h have the same basic configuration, the configuration of the arrangement base 32e will be mainly described below. The same reference signs as those used for the arrangement base 32e are also used for the arrangement bases 32f-32h.

As shown in FIG. 6B, the arrangement base 32e has such a shape that both ends of one plate are bent in the same direction. The arrangement base 32e includes an arrangement part 320, a wall part 321, and a wall part 322.

The spring 32a is arranged on an upper surface 320a of the arrangement part 320. This arrangement allows for electrical conduction between the spring 32a and the arrangement base 32e. That is, there is electrical conduction between the detection electrode 31a, the spring 32a and the arrangement base 32e. As a modification, raised parts to be inserted into the centers of the springs may be provided on the upper surfaces 320a in contact with the springs 32a-32d.

The arrangement parts 320 are attached to the sub-substrate 34 so that lower surfaces 320b are in contact with electrode pads 341-344 provided on an arrangement surface 34a of the sub-substrate 34, as shown in FIGS. 7A and 7B. The arrangement bases 32e-32h are attached to the electrode pads 341-344 by using solder or a conductive adhesive, etc., but it is not limited thereto. Screws may be used.

The electrode pad 341 is electrically conducted to the detection electrode 31a via the arrangement base 32e and the spring 32a. The electrode pad 342 is electrically conducted to the detection electrode 31b via the arrangement base 32f and the spring 32b, The electrode pad 343 is electrically conducted to the detection electrode 31c via the arrangement base 32g and the spring 32c. The electrode pad 344 is electrically conducted to the detection electrode 31d via the arrangement base 32h and the spring 32d.

In other words, the conduction part 32 acts as a cable which electrically connects the detection electrode 31a to the electrode pad 341, the detection electrode 31b to the electrode pad 342, the detection electrode 31c to the electrode pad 343, and the detection electrode 31d to the electrode pad 344.

The wall part 321 and the wall part 322 face each other. A bent part 321a is formed between the wall part 321 and the arrangement part 320. A bent part 322a is formed between the wall part 322 and the arrangement part 320.

The electrode pad 341 on the front region 301 side is arranged on the sub-board 34 at a position slightly rotated counterclockwise relative to the vertical direction of the paper of FIG. 7B. Meanwhile, the electrode pad 342 is arranged on the sub-board 34 at a position slightly rotated clockwise relative to the vertical direction of the paper of FIG. 7B. The electrode pad 341 and the electrode pad 342 are line symmetric with respect to an axis on a line 347 indicated by as a dash-dot line in FIG. 7B. Thus, the arrangement base 32e is arranged at a position slightly rotated counterclockwise so as to correspond to the electrode pad 341. Likewise, the arrangement base 32f is arranged at a position slightly rotated clockwise so as to correspond to the electrode pad 342.

On the other hand, the electrode pad 343 and the electrode pad 344 on the rear region 302 side are not rotated in the vertical and horizontal directions of the paper of FIG. 7B and are line symmetric with respect to an axis on the line 347. Thus, the arrangement base 32g and the arrangement base 32h are arranged to be line symmetric with respect to an axis on the line 347 so as to correspond to the electrode pad 343 and the electrode pad 344.

Configuration of the First Control Unit 33

The first control unit 33 is a microcomputer composed of a CPU (=Central Processing Unit) performing calculation and processing, etc., of the acquired data according to a stored program, and a RAM (=Random Access Memory) and a ROM Read Only Memory) as semiconductor memories, etc. The ROM stores a program for operation of the first control unit 33. The RAM is used as a storage area to temporarily store calculation results, etc. The first control unit 33 also has, inside thereof, a means to generate a clock signal and operates based on the clock signal.

The first control unit 33 is, e.g., an electrostatic sensor IC (=Integrated Circuit). The electrostatic sensor 39 has the detection electrode unit 31, the conduction part 32, and the first control unit 33.

Since the electrostatic sensor 39 is of the self-capacitance type, capacitance increases when the operation finger of the user comes in proximity or contact with the detection electrode unit 31. The first control unit 33 has an electrostatic threshold value 330 in the RAM or the ROM and determines proximity or contact of the operation finger of the user when capacitance of not less than the electrostatic threshold value 330 is detected. The electrostatic sensor 39 can detect proximity. Therefore, even if the user performs an operation on the operation knob 30 without touching the detection electrode unit 31, the first control unit 33 can determine the operation region.

The first output signal S₁ acquired by the first control unit 33 via the detection electrode unit 31 and the conduction part 32 is an analog signal. The first control unit 33 calculates capacitance based on the first output signal St and determines whether or not there is proximity or contact. The first output signal S₁ is a signal allowing capacitance of each of the detection electrodes 31a-31d to be calculated, and it may be, e.g., a signal group output from each of the detection electrodes 31a-31d, or may be a signal obtained by periodically connecting to the detection electrodes 31a-31d, but it is not limited thereto.

The first control unit 33 determines whether or not there is proximity or contact for each of the detection electrodes 31a-31d, and outputs the result as the second output signal S₂. The second output signal S₂ is a digital signal.

That is, in the operation knob unit 3, the analog signal, which degrades more as the transmission distance increases, is processed in the housing part 306 of the operation knob 30 in which the transmission distance is short and which is less likely affected by noise. The operation knob unit 3 then sends a digital signal, which degrades less than the analog signal, to the main substrate 4 of the main body 2.

Configuration of the Sub-Substrate 34

The sub-substrate 34 is a printed circuit board. As shown in FIGS. 7A and 7B, the first control unit 33, the electrode pads 341-344 and light-emitting elements 345 are arranged on the arrangement surface 34a of the sub-substrate 34. The light-emitting elements 345 are LED (=Light Emitting Diode) elements and illuminate the operation knob 30. The first control Lunt 33 is electrically connected to the electrode pads 341-344.

A connector 346 is arranged on a back surface 34b of the sub-substrate 34. The cable 10 is connected to the connector 346. The cable 10 is a flat cable and is electrically connected to the connector 346 of the sub-substrate 34 and a connector 46 of the main substrate 4. That is, the cable 10 electrically connects the sub-substrate 34 to the main substrate 4.

The springs 32a-32d are compressed by the cover 35 attached to the operation knob 30 by the screws 36. That is, the springs 32a-32d attached to the operation knob 30 have a length shorter than the natural length, and thus can apply pressure by an elastic force to the detection electrodes 31a-31d and the arrangement bases 32e-32h and maintain contact therewith.

(Configuration of the Main Substrate 4)

The main substrate 4 is a printed circuit board. As shown in FIG. 1, the second control unit 41, electrode patterns 42-45 and an electrode pattern 47 are arranged on an arrangement surface 4a of the main substrate 4. In addition, the connector 46 is arranged on a back surface 4b of the main substrate 4. The second control unit 41 is electrically connected to the electrode patterns 42-45 and the electrode pattern 47.

The second control unit 41 is a microcomputer composed of a CPU performing calculation and processing, etc., of the acquired data according to a stored program, and a RAM and a ROM as semiconductor memories, etc. The ROM stores a program for operation of the second control unit 41. The RAM is used as a storage area to temporarily store calculation results, etc. The second control unit 41 also has, inside thereof, a means to generate a clock signal and operates based on the clock signal. This clock signal is synchronized with the first control unit 33.

As shown in FIG. 2B, the second control unit 41 determines the operated operation region based on the second output signal S₂ acquired from the operation knob unit 3, and also determines the performed operation based on a third output signal S₃ acquired from the operation detection unit 6. The second control unit 41 generates the instruction signal S₄ indicating the determination result and outputs it to the window opening/closing device 95. The window opening/closing device 95 drives the window of the vehicle 9 based on the instruction signal S₄.

The switch device 1 includes a manual mode and an automatic mode. The manual mode is a mode in which the selected window is driven while the operation knob 30 is being operated. The automatic mode is a mode in which when an operation is performed on the operation knob 30, the selected window is driven until fully opened or closed. The pull-up operation and the push-down operation have two stages; the first stage is the manual mode, and the second stage operated further than the first stage is the automatic mode.

The second control unit 41 determines whether it is the manual mode or the automatic mode based on the third output signal S₃ from the operation detection unit 6.

The electrode patterns 42-45 and the electrode pattern 47 are, e.g., in a shape of a circular pattern with a center portion removed. In FIG. 8B, the electrode pattern 47 having such a shape is shown as an example. The electrode patterns 42-45 and the electrode pattern 47 do not have the middle portion of the circular pattern as described above and are thus disconnected at the middle. Rubber domes 51-54 of the rubber dome sheet 5 are located above the electrode patterns 42-45, as shown in FIG. 1. A rubber dome 56 is located above the electrode pattern 47.

The rubber dome sheet 5 is formed using a soft resin material such as silicone and has a thin sheet shape. The rubber dome sheet 5 is provided with a housing part 5c on a lower surface 5b side. The rubber dome sheet 5 suppresses ingress of liquid to the main substrate 4, i.e., provides waterproof by housing the main substrate 4 in the housing part 5c.

The rubber domes 51-54 have conductive contacts 510-540, and the contacts 510-540 come into contact with the electrode patterns 42-45 and thereby provide electrical conduction to the electrode patterns 42-45. That is, the rubber dome is deformed by the push-down operation or the pull-up operation performed on the operation knob 30, the contact thus comes into contact with the electrode pattern and thereby provides electrical conduction to the electrode pattern. The conducted state means that the switch is ON, and the non-conducted state means OFF.

The rubber dome sheet 5 further includes the rubber dome 56. The rubber dome 56 has a conductive contact 560 and is arranged so as to correspond to the electrode pattern 47 on the main substrate 4. The rubber dome 56 is deformed by a push operation on the operation button 12, which causes the contact 560 to come into contact with the electrode pattern 47 and thereby provide electrical conduction to the electrode pattern 47.

Top ends of the rubber domes 51-54 and the rubber dome 56 protrude beyond a front surface 5a of the rubber dome sheet 5. These protruding parts of the rubber domes 51-54 are in contact with a slider 63 and a slider 64.

(Configuration of the Operation Detection Unit 6)

As shown in FIG. 1, the operation detection unit 6 has the rod 61 and the rod 62, the slider 63 and the slider 64, the rubber domes 51-54, and the electrode patterns 42-45

The rod 61, the slider 63, the rubber dome 51, the rubber dome 52, the electrode pattern 42 and the electrode pattern 43 constitute two switches with different functions. The rod 62, the slider 64, the rubber dome 53, the rubber dome 54, the electrode pattern 44 and the electrode pattern 45 constitute two switches with different functions. That is, the operation detection unit 6 has four switches with different functions.

The rod 61 and the rod 62 are formed using a resin material and have a quadrangular prism shape. The slider 63 and the slider 64 are formed using a resin material and have a quadrangular prism shape. The slider 63 is arranged so as to be in contact with the rubber dome 51 and the rubber dome 52 of the rubber dome sheet 5. The slider 64 is arranged so as to be in contact with the rubber dome 53 and the rubber dome 54.

The upper part 610 and the upper part 620 of the rod 61 and the rod 62 have a semicircular cross section such as a side face of a column. A lower part 611 and a lower part 621 also have the same shape as the upper part 610 and the upper part 620.

The upper part 610 of the rod 61 is in contact with the protrusion 304a of the operation knob 30. The upper part 620 of the rod 62 is in contact with the protrusion 304b of the operation knob 30.

As shown in FIG. 8B, the lower part 611 of the rod 61 is movably inserted into a guide groove 630 of the slider 63. The lower part 621 of the rod 62 is movably inserted into a guide groove 640 of the slider 64.

The push-down operation on the operation knob 30 is detected by the rod 61, the slider 63, the rubber dome 51, the rubber dome 52, the electrode pattern 42 and the electrode pattern 43. Meanwhile, the pull-up operation on the operation knob 30 is detected by the rod 62, the slider 64, the rubber dome 53, the rubber dome 54, the electrode pattern 44 and the electrode pattern 45.

When the operation knob 30 is pushed down, the protrusion 304a pushes the upper part 610 of the rod 61. The lower part 611 of the pushed rod 61 pushes down the slider 63. At this time, since the rod 61 is located on the front side of the slider 63, i.e., located on the rubber dome 51 side as shown in FIG. 8B, the contact 510 of the rubber dome 51 comes into contact with the electrode pattern 42 and is turned on. When the operation knob 30 is further pushed down, the rod 61 further pushes down the slider 63, the rod 61 moves in the guide groove 630 to the rear side, i.e., to a position between the rubber dome 51 and the rubber dome 52, and the contact 510 and the contact 520 of the rubber dome 51 and the rubber dome 52 come into contact with the electrode pattern 42 and the electrode pattern 43 and are turned on.

On the other hand, when the operation knob 30 is pulled up, the protrusion 304b pushes the upper part 620 of the rod 62. The lower part 621 of the pushed rod 62 pushes down the slider 64. At this time, since the rod 62 is located on the rear side of the slider 64, i.e., located on the rubber dome 54 side as shown in FIG. 8B, the contact 540 of the rubber dome 54 comes into contact with the electrode pattern 45 and is turned on. When the operation knob 30 is further pulled up, the rod 62 further pushes down the slider 64, the rod 62 moves in the guide groove 640 to the front side, i.e., to a position between the rubber dome 53 and the rubber dome 54, and the contact 530 and the contact 540 of the rubber dome 53 and the rubber dome 54 come into contact with the electrode pattern 44 and the electrode pattern 45 and are turned on.

That is, when the operation knob 30 is pushed down, a mode when the rubber dome 51 is in the ON state is the manual mode in which the window is driven in a closing direction, and a mode when the rubber dome 51 and the rubber dome 52 are in the ON state is the automatic mode in which the window is driven until fully closed.

On the other hand, when the operation knob 30 is pulled up, a mode when the rubber dome 54 is in the ON state is the manual mode in which the window is driven in an opening direction, and a mode when the rubber dome 53 and the rubber dome 54 are in the ON state is the automatic mode in which the window is driven until fully opened.

The rubber domes of the switch device 1 have different shapes so that operation feeling is different between the manual mode and the automatic mode. That is, the rubber dome 51 and the rubber dome 52 have different shapes. Likewise, the rubber dome 53 and the rubber dome 54 have different shapes.

The rubber dome 51 and the rubber dome 54 have the same shape so that operation feeling in the manual mode is similar for the pull-up operation and the pull-up operation. Likewise, the rubber dome 52 and the rubber dome 53 have the same shape so that operation feeling in the automatic mode is similar for the pull-up operation and for the pull-up operation.

Next, an example of an operation of the switch device 1 in the present embodiment will be described. A case where the user opens and closes a driver's side window 91 will be described.

(Operation)

Push-Down Operation

When a user tries to push down the right front-side operation region 301b of the operation knob 30 to open the driver's side window 91, the detected capacitance which is inversely proportional to a distance between the operation finger and the detection electrode 31b increases since the operation finger of the user comes in proximity to the detection electrode 31b.

Based on the first output signal S₁ acquired from the detection electrode unit 31, the first control unit 33 of the operation knob unit 3 determines that the operation finger is in proximity to or contact with the detection electrode 31b which detected capacitance not less than the electrostatic threshold value 330. The first control unit 33 outputs the second output signal S₂, which indicates that the operation finger is in proximity to or contact with the detection electrode 31b, to the second control unit 41.

Next, when the user pushes down the right front-side operation region 301b of the operation knob 30, the operation knob 30 causes deformation of the rubber dome 51 through the rod 61 and the slider 63 and pushes down the contact 510, causing electrical conduction to the electrode pattern 42. By this electrical conduction, the operation detection unit 6 outputs the third output signal S₃, which indicates that the electrode pattern 42 is electrically conducted, to the second control part 41.

Based on the second output signal S₂ and the third output signal S₃, the second control unit 41 outputs the instruction signal S₄, which indicates that the push-down operation on the detection electrode 31b is being performed in the manual mode, during being pushed.

Then, when the user further pushes down the operation knob 30, it provides electrical conduction to the electrode pattern 42 and the electrode pattern 43. By this electrical conduction, the operation detection unit 6 outputs the third output signal S₃, which indicates that the electrode pattern 42 and the electrode pattern 43 are electrically conducted, to the second control part 41.

Based on the second output signal S₂ and the third output signal 53, the second control unit 41 outputs the instruction signal S₁ which indicates that the push-down operation on the detection electrode 31b is performed in the automatic mode.

Pull-Up Operation

When the user tries to pull up the right front-side operation region 301b of the operation knob 30 to close the driver's side window 91, the detected capacitance which is inversely proportional to the distance between the operation finger and the detection electrode 31b increases since the operation finger of the user comes in proximity to the detection electrode 31b.

Based on the first output signal S₁ acquired from the detection electrode unit 31, the first control unit 33 of the operation knob unit 3 determines the operation finger is in proximity or contact with the detection electrode 31b which detected capacitance not less than the electrostatic threshold value 330. The first control unit 33 outputs the second output signal S₂, which indicates that the operation finger is in proximity to or contact with the detection electrode 31b, to the second control unit 41.

Next, when the user pulls up the right front-side operation region 301b of the operation knob 30, the operation knob 30 deforms the rubber dome 54 through the rod 62 and the slider 64 and pushes down the contact 540, causing electrical conduction to the electrode pattern 45, By this electrical conduction, the operation detection unit 6 outputs the third output signal S₃, which indicates that the electrode pattern 45 is electrically conducted, to the second control part 41.

Based on the second output signal S₂ and the third output signal S₃, the second control unit 41 outputs the instruction signal S₄, which indicates that the pull-up operation on the detection electrode 31b is being performed in the manual mode, during being pushed.

Then, when the user further pulls up the operation knob 30, it provides electrical conduction to the electrode pattern 44 and the electrode pattern 45. By this electrical conduction, the operation detection unit 6 outputs the third output signal S₃, which indicates that the electrode pattern 44 and the electrode pattern 44 are electrically conducted, to the second control part 41.

Based on the second output signal S₂ and the third output signal S₃, the second control unit 41 outputs the instruction signal S₄ which indicates that the pull-up operation on the detection electrode 31b is performed in the automatic mode.

### Effects of the Embodiment

The switch device 1 in the present embodiment can reduce the effect of noise. In particular, in the switch device 1, the determination result is output from the operation knob unit 30. Therefore, the transmission distance from the detection electrode unit 31 to the first control unit 33, which is likely to be affected by noise, is short as compared to when contact is determined by a control unit arranged in the main body rather than the operation knob. Therefore, the switch device 1 can suppress the effect of noise.

In the switch device 1, contact is determined in the operation knob unit 3 from which a digital signal is output to the body 2. Therefore, as compared to when an analog signal is output from the operation knob to the main body, the switch device 1 is less likely to be affected by noise since the transmission distance at which an analog signal flows is short and a digital signal flows through the cable 10 as a transmission path from the operation knob 30 to the main body 2.

In the switch device 1, the surface 300 of the operation knob 30 is divided into plural operation regions, and the push-down operation and the pull-up operation can be determined for each operation region. Therefore, as compared to when provided with plural operation knobs, two types of functions can be instructed for every operation region even though there is only one operation knob 30.

The switch device 1 includes one operation knob 30 but has eight different functions: functions of giving instructions to open and close the left and right front windows and open and close the left and right rear windows. Therefore, the switch device 1 can be reduced in size as compared to when four operation knobs are required to instruct the same functions.

The switch device 1 has one operation knob 30 and thus can have a space for arranging the sub-substrate 34, as compared to when provided with plural operation knobs corresponding to the functions.

The switch device 1 can detect proximity of the operation finger and thus can determine the operation region quicker than when detecting only contact. Therefore, the second control unit 41 of the switch device 1 can quickly determine the operation.

Since the switch device 1 uses the conduction part 32 for electrical connection between the detection electrode unit 31 and the electrode pads 341-344, it is possible to reduce the cost as compared to when using a cable. Meanwhile, flat cables, when bent, are likely to affected by noise. Since the switch device 1 uses the conduction part 32, the effect of noise can be further suppressed as compared to when using a flat cable.

The switch device 1 uses the springs 32a-32d to electrically connect the detection electrodes 31a-31d to the arrangement bases 32e-32h. Therefore, contact is easily maintained and conduction failure can be suppressed, as compared to when using a conductive member with no elasticity.

Although the embodiment and modifications of the invention has been described, the embodiment and modifications are merely an example and the invention according to claims is not to be limited thereto. The new embodiment and modifications thereof may be implemented in various other forms, and various omissions, substitutions and changes, etc., can be made without departing from the gist of the invention. In addition, not all combinations of the features described in the embodiment and modifications are necessary to solve the problem of the invention. Further, the embodiment and modifications thereof are included within the scope and gist of the invention and also within the invention described in the claims and the range of equivalency.

### REFERENCE SIGNS LIST

1 SWITCH DEVICE
2 MAIN BODY
3 OPERATION KNOB UNIT
4 MAIN SUBSTRATE
6 OPERATION DETECTION UNIT
9 VEHICLE
10 CABLE
30 OPERATION KNOB
31 DETECTION ELECTRODE UNIT
31a-31d DETECTION ELECTRODE
32 CONDUCTION PART
32a-32d SPRING
32e-32h ARRANGEMENT BASE
33 FIRST CONTROL UNIT
34 SUB-SUBSTRATE
39 ELECTROSTATIC SENSOR
41 SECOND CONTROL UNIT
91 WINDOW
95 WINDOW OPENING/CLOSING DEVICE
301 FRONT REGION
301a LEFT FRONT-SIDE OPERATION REGION
301b RIGHT FRONT-SIDE OPERATION REGION
302 REAR REGION
302a LEFT REAR-SIDE OPERATION REGION
302b RIGHT REAR-SIDE OPERATION REGION
306 HOUSING PART

1. A switch device, comprising:
an operation knob unit integrally comprising an operation knob, a detection part to detect proximity to or contact with the operation knob, a conduction part electrically connected to the detection part, a first control unit that is electrically connected to the detection part via the conduction part, determines proximity to or contact with the operation knob based on a first output signal outputted from the detection part and outputs a determination result as a second output signal, and a sub-substrate that is attached to the operation knob and comprises the first control unit.

2. The switch device according to claim 1, wherein the operation knob is open on a lower surface and comprises a housing part therein, and wherein the sub-substrate and the conduction part are housed in the housing part.

3. The switch device according to claim 1 or 2, wherein the operation knob comprises a surface divided into a plurality of operation regions, wherein the detection part is arranged in each of the plurality of operation regions, and wherein the first control unit determines it is proximity to or contact with which operation region among the plurality of operation regions based on the first output signal, and outputs the second output signal indicating an operation region in which proximity or contact is detected.

4. The switch device according to claim 1, wherein the surface of the operation knob is divided into a plurality of regions by at least one recessed part formed thereon, and the plurality of regions are further divided into the plurality of operation regions.

5. The switch device according to claim 1, wherein the detection part comprises an electrode part of the self-capacitance type electrostatic sensor to detect a change in capacitance caused by proximity or contact.

6. The switch device according to claim 1, wherein the detection part comprises a sensor part comprising at least one of a pressure sensor and a load sensor to detect the contact.

7. The switch device according to claim 1, wherein the conduction part comprises a coil spring comprising a metal material and electrically connecting the detection part to an electrode pad of the sub-substrate, and an arrangement base formed using a metal plate and interposed between the coil spring and the electrode pad.

8. The switch device according to claim 1, further comprising:
a main body to which the operation knob unit is attached;
an operation detection unit to detect an operation performed on the operation knob;
a cable electrically connected to the first control unit;
a second control unit that acquires the second output signal outputted by the first control unit through the cable and outputs an instruction signal to give an instruction to an operation target based on the operation detected by the operation detection unit and the second output signal; and
a main substrate which is arranged in the main body and is electrically connected to the sub-substrate via the cable and on which the operation detection unit and the second control unit are mounted.

9. The switch device according to claim 8, wherein the operation knob comprises a surface divided into a plurality of operation regions and is attached to the main body so that pull-up operation and push-down operation thereof can be performed about a rotation axis, wherein the operation detection unit outputs a third output signal indicating which of the pull-up operation and the push-down operation is performed, and wherein the second control unit outputs the instruction signal indicating an operated operation region and a performed operation to the operation target based on the second output signal outputted from the operation knob unit and the third output signal outputted from the operation detection unit.

10. The switch device according to claim 9, wherein the operation target comprises a window opening/closing device to open/close a window of a vehicle, wherein the operation knob comprises at least four operation regions corresponding to left and right front windows and left and right rear windows of the vehicle, and wherein the second control unit determines an operated operation region and a performed operation based on the second output signal and the third output signal, and outputs the instruction signal indicating which window is to be opened or closed.
